(19) United States
(12) Patent Application Publication
(10) Pub. No.: US 2005/0068024 A1
(43) Pub. Date: Mar. 31, 2005

(54) Rotary position sensor

(76) Inventor: Robert James Byram, Grand Blanc, MI (US)

Correspondence Address: DELPHI TECHNOLOGIES, INC., M/C 480-410-202, PO BOX 5052, TROY, MI, 48007, US

(21) Appl. No.: 10/673,589

(22) Filed: Sep. 29, 2003

(51) Int. Cl. G01B 7/30

(52) U.S. Cl. 324/207.25; 324/207.2; 324/207.21

(57) ABSTRACT

A rotary position sensor (200) includes a magnet assembly (200′) having first and second poles (26, 28), a nonuniform magnetic field (B″) in a working air gap (22″) between the poles, and an axis of rotation (A, A′, A″). A magnetosensitive device (24″) is located within the working air gap (22″) at a first selected distance (X, Y, Z) from the axis of rotation (A, A′, A″). For a given range of motion, the magnetosensitive device (24″) is subjected to a progressively increasing magnetic flux density (R, R′). The component of the output signal due to this increasing flux density is additive to the component due simply to rotation of the magnetic field (B″) about the magnetosensitive device (24″), effectively reducing the total output signal's deviation from linearity. Alternatively, a magnet assembly (300′) includes a pair of pole pieces (310, 312) and a nonuniform magnetic field (B′″) in a working air gap (22′″) between the pole pieces (310, 312). A magnetosensitive device (24′″) is located within the working air gap (22′″) at a first selected distance (X′) from the axis of rotation (A′″).

### TECHNICAL FIELD

The present invention relates to rotary position sensors used to sense rotary movement using a sensor including a magnetosensitive device, such as a Hall effect device, and more particularly to an arrangement of a magnetosensitive device within the working air gap of a magnetic field assembly for a rotary position sensor.

### BACKGROUND OF THE INVENTION

Rotary position sensors utilize a magnetic field and a magnetosensitive device, such as a Hall effect device or a magnetoresistor located within the magnetic field. To detect rotational movement as between a first article (such as for example a rotatable shaft of a control valve) and a second article (such as for example a stationary base), the magnetic field is oriented transverse in relation to the axis of rotation of the first article, and the magnetosensitive device is located inside the magnetic field. The member providing the magnetic field is connected to one of the articles, and the magnetosensitive device is connected to the other article. As the articles rotate relative to each other, the magnetosensitive device is caused to change its angular position relative to the magnetic field direction, resulting in a change of output signal from the magnetosensitive device responsive to its angle with respect to the magnetic field direction. This change in signal is indicative of the angular position as between the first and second articles.

FIGS. 1 and 2 depict a typical configuration of a prior art rotary position sensor 10. A shaft 12 supports a magnet assembly 14 including two mutually opposed permanent magnet arcs 16, 18 and an outer flux carrying ring 20. A working air gap 22 is provided between the magnet arcs 16, 18, wherein a nonuniform magnetic field B is provided therebetween having a direction indicated by arrowheads D, locally defined by lines of magnetic flux L. The magnet arcs 16, 18 are glued or bonded into place on the outer flux carrying ring 20. The axis of rotation for position sensor 10 is aligned with the center of nonuniform magnetic field B. A magnetosensitive device 24 (as for example an ASIC chip, such as a Melexis MLX90215 or Allegro ATS635LSB) having a reference direction T is placed into the working air gap 22 in line with the axis of rotation, and is connected to a base 26 by at least one peg 28.

FIG. 3 is a graph of magnetic field strength B versus angular position measured for the prior art rotary position sensor of FIG. 2, depicting the deviation from linearity or sinusoidal nature of the output signal. Because of this it is desirable to operate such a sensor within a range of about ±45 degrees or less from the zero output position, in order to minimize the signal's deviation from linearity. A linear signal is desirable because it improves the accuracy of a given electromechanical control system. Furthermore, the cost of the overall control system can be reduced if the position sensor does not require extra components or signal processing in order to achieve a substantially linear response. For FIGS. 2 and 3, positive rotation of magnet assembly 14 with respect to magnetosensitive device 24 is defined as clockwise rotation, and produces a negative output signal. Furthermore, defining a desired sensor response, in this case, as: 1. substantially zero gauss at zero degrees of rotation and 2. matching the position sensor's output at ±45 degrees, the maximum output signal error from a line J drawn through these three data points occurs at angular positions of about ±22.5 degrees. A method for estimating this maximum output signal error is described by the following equation:
Max. error at ⁻22.5 degrees=sin⁻¹[(sin(⁻45 degrees))/2]−⁻22.5 degrees=⁺1.8 degrees (estimated)
This estimated maximum output signal error is indicated in FIG. 3 by arrows at V.

One known method of decreasing this deviation from linearity is to use ferromagnetic flux shapers within the magnet assembly. FIG. 4 shows a prior art rotary position sensor 100 having flux shapers. A shaft (not shown) supports a magnet assembly 100′ including two mutually opposed permanent magnet arcs 16′, 18′ and an outer flux carrying ring 20′. A working air gap 22′ is provided between the magnet arcs 16′, 18′, wherein a nonuniform magnetic field B′ is provided therebetween having a direction indicated by arrowheads D′, locally defined by lines of magnetic flux L′. The magnet arcs 16′, 18′ are glued or bonded into place on the outer flux carrying ring 20′. The axis of rotation for position sensor 100 is aligned with the center of nonuniform magnetic field B′. A magnetosensitive device 24′ is placed into the working air gap 22′ in line with the axis of rotation, and sandwiched by a pair of semicircular ferromagnetic (steel) flux shapers 102a, 102b. The flux shapers 102a, 102b are fixed in relation to the magnetosensitive device 24′ and collectively form a sensor package 104. The flux shapers concentrate and linearize the lines of magnetic flux passing through them. In this way the magnetosensitive device is exposed to a more uniform magnetic field. However the flux shapers are additional components which increase the cost to make and produce the position sensor, as well as increase the complexity of the device and potentially affect its reliability.

What remains needed in the art is a rotary position sensor which is robust, yet simply constructed, and which provides a substantially linear output signal through a useful range of motion while eliminating the cost and complexity associated with ferromagnetic flux shapers.

### SUMMARY OF THE INVENTION

The present invention is a rotary position sensor featuring a robust and simply constructed arrangement for a magnetosensitive device within the working air gap of a magnetic field assembly.

The present invention is a rotary position sensor having an axis of rotation, comprising a magnet assembly having first and second poles, wherein a working air gap is provided between the first and second poles, a magnetosensitive device having a reference point, wherein the reference point is located within the working air gap, wherein the axis of rotation to the reference point is a first selected distance greater than zero millimeters (mm), and wherein the working air gap is a second selected distance.

The rotary position sensor according to the present invention includes a magnet assembly having first and second poles, and a nonuniform magnetic field provided in a working air gap between the first and second poles, wherein the position sensor's axis of rotation is within the magnetic field. The magnet assembly is connected to a first article. A magnetosensitive device is located within the working air gap and connected to a second article, so as to permit measurement of the relative angular displacement between the articles. Furthermore, the magnetosensitive device is located at a first selected distance greater than zero mm from the position sensor's axis of rotation. At an initial position for the position sensor, the magnetosensitive device is oriented within the magnetic field so as to produce a substantially zero output signal. Due to the nonuniform magnetic field and the eccentric location of the magnetosensitive device relative to the axis of rotation, as the magnitude of rotary motion for the magnet assembly increases with respect to the initial position, the magnetosensitive device is subjected to a progressively increasing magnetic flux density. The component of the magnetosensitive device's output signal due to the progressively increasing flux density is additive to the component of the output signal due simply to rotation of the magnetic field about the magnetosensitive device. In other words, the component of the signal due to the progressively increasing flux density tends to counteract the sinusoidal nature of the output signal due to rotation of the magnetic field about the magnetosensitive device. This effectively reduces the total output signal's deviation from linearity without using other elements such as ferromagnetic flux shapers.

The rotary position sensor according to another embodiment of the present invention includes a magnet assembly having a pair of pole pieces composed of ferromagnetic material in good contact with the respective poles of a permanent magnet, thereby providing minimal reluctance to the magnetic circuit at the interface therebetween. A nonuniform magnetic field is provided in a working air gap between the pole piece faces. The position sensor's axis of rotation is located between the permanent magnet and a magnetosensitive device that is within the working air gap for at least a portion of the sensor's angular range of motion. Furthermore, the axis of rotation is located along an imaginary line, wherein the imaginary line is a centerline of the permanent magnet that passes through the working air gap. Furthermore, the magnetosensitive device is located at a first selected distance greater than zero mm from the axis of rotation.

The present invention has the advantage of linearizing the output signal of a rotary position sensor without the cost and complexity of using ferromagnetic flux shapers.

The present invention has the advantage of permitting control over the location of the magnetosensitive device within the working air gap of a rotary position sensor, through selection of the distance between the magnetosensitive device and the sensor's axis of rotation.

The present invention has the advantage of being adaptable to various magnet assemblies, including for example those with magnetic elements such as permanent magnet arcs, ring magnets, “U-shaped” magnets, rectangular or bar magnets with pole pieces, and two rectangular or bar magnets used as individual magnetic elements.

The present invention has the advantage of extending the angular range of motion for which substantially linear response can be obtained.

The present invention has the advantage of optimizing the linearity of the output signal by controlling the location of the axis of rotation and the distance between the magnetosensitive device and axis of rotation, thereby permitting calibration of the output signal contributions due to increasing flux density and rotation of the magnetic field.

This and additional objects, features and advantages of the present invention will become clearer from the following specification of a preferred embodiment.

### BRIEF DESCRIPTION OF THE DRAWINGS

FIG. 1 is a partly sectional side view of a prior art rotary position sensor which is press-fit onto a shaft end.

FIG. 2 is an end view of the working air gap environs for the prior art rotary position sensor of FIG. 1 as seen along line 2-2, depicting the magnetic field.

FIG. 3 is a graph of magnetic field strength versus angular position for the prior art rotary position sensor of FIGS. 1 and 2.

FIG. 4 is an end view of the working air gap environs for a prior art rotary position sensor having ferromagnetic flux shapers, depicting the magnetic field.

FIG. 5 is an end view of the working air gap environs for a rotary position sensor according to the present invention depicting the magnetic field, shown at an initial position of the magnet assembly with respect to a stationary base.

FIG. 6 is an end view of the working air gap environs of FIG. 5 depicting the magnetic field, wherein the magnet assembly has rotated 45 degrees counterclockwise from an initial position with respect to a stationary base.

FIG. 7 is an end view of the working air gap environs of FIG. 5 depicting the magnetic field, wherein the magnet assembly has rotated 45 degrees clockwise from an initial position with respect to a stationary base.

FIG. 8 is a graph of magnetic field strength versus angular position for the rotary position sensor of FIG. 5.

FIG. 9 is an end view of the working air gap environs for an alternate rotary position sensor according to the present invention depicting the magnetic field, shown at an initial position of the magnet assembly with respect to a stationary base.

FIG. 10 is an end view of the working air gap environs for an alternate rotary position sensor according to the present invention depicting the magnetic field, wherein the magnet assembly has rotated 45 degrees clockwise from an initial position with respect to a stationary base.

FIG. 11 is another graph of magnetic field strength versus angular position for the prior art rotary position sensor of FIGS. 1 and 2, wherein the magnetic field strength is shown not to scale for the purpose of illustrating the operation of the invention.

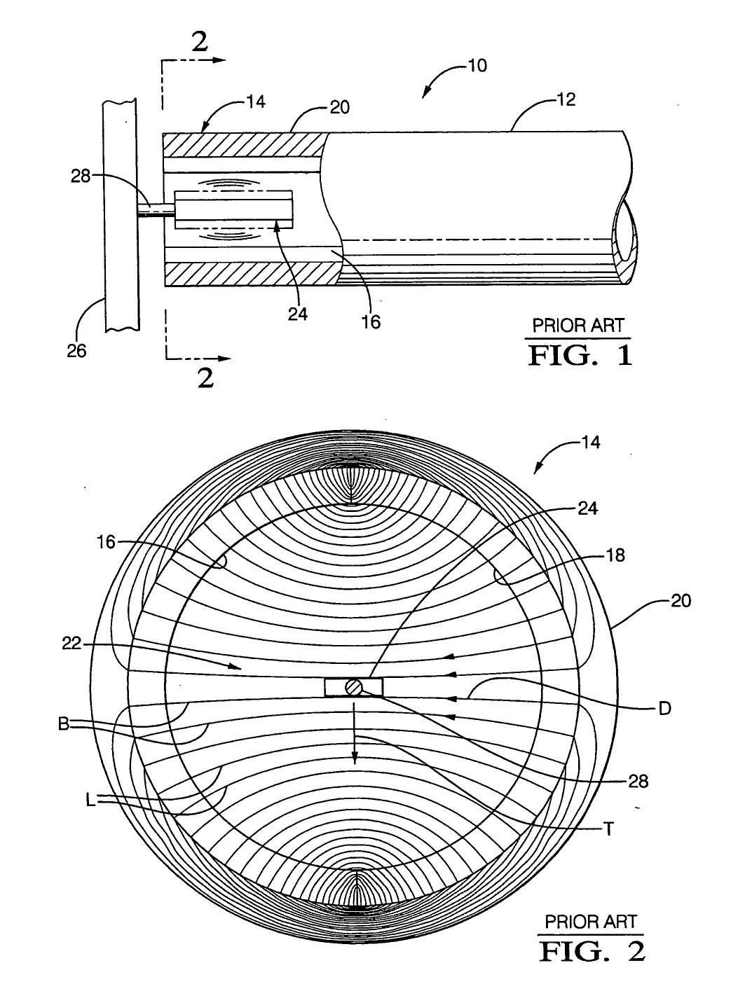

### DESCRIPTION OF THE PREFERRED EMBODIMENT

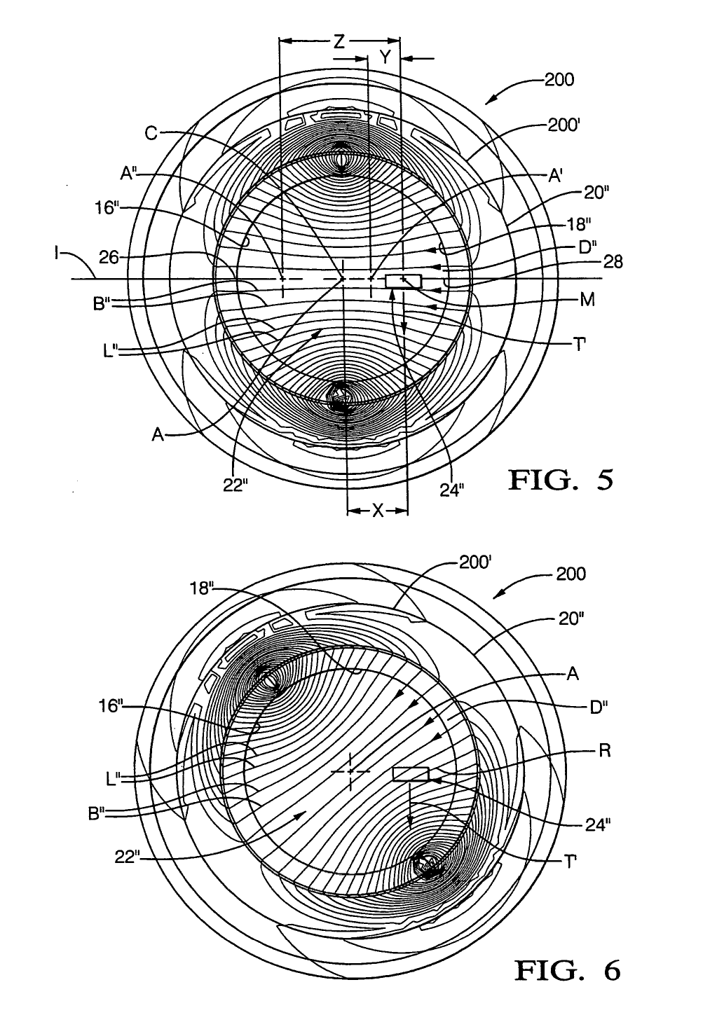

Referring now to the Drawings, FIGS. 5 through 11 depict examples of a rotary position sensor according to the present invention.

Turning attention firstly to FIGS. 5 through 8 and 11, aspects of a first rotary position sensor 200 according to the present invention are depicted. The rotary position sensor 200 includes a magnet assembly 200′ supported by a shaft (not shown) having two mutually opposed permanent magnet arcs 16″, 18″, that are glued or bonded into place on an outer flux carrying ring 20″. The permanent magnet arcs are formed from a magnetic material such as for example “bonded,” i.e. plastic injection molded, samarium-cobalt Sm₂Co₁₇ or SmCo₅. Alternatively, the magnet arcs could be formed by sintering. Magnet assembly 200′ can also be comprised of magnetic elements such as a ring magnet of unitary construction with two magnetic poles, two individual rectangular or bar magnets separated by a working air gap, etc. For the present embodiment a working air gap 22″ is provided between the permanent magnet arcs 16″, 18″, wherein a nonuniform magnetic field B″ is provided therebetween having a direction indicated by arrowheads D″, locally defined by lines of magnetic flux L″ emanating from the respective permanent magnet poles 26, 28. Referring to FIG. 5, a magnetosensitive device 24″ having a reference direction indicated by arrow T′ is located within the working air gap 22″ of magnet assembly 200′. Furthermore, magnetosensitive device 24″ has a reference point M located at a first selected distance greater than zero mm X from the axis of rotation A. The working air gap 22″ is a second selected distance. The reference direction is oriented substantially perpendicular to an imaginary plane passing through the reference point and the axis of rotation. In an exemplary embodiment the first selected distance X is about one to about two millimeters (mm), and the second selected distance between the permanent magnet arcs, each having an inner radius of about five mm, is about ten mm. The axis of rotation A is located on imaginary line I between permanent magnet poles 26, 28, at the center C of nonuniform magnetic field B″. Axis of rotation A is not skewed with respect to magnet assembly 200′ but rather is substantially parallel to the longitudinal axis (not shown) of the rotary position sensor. For purposes of describing this invention, “parallel” to a given axis or line includes “coincident” with the given axis or line. Magnet assembly 200′ is connected to a first article and magnetosensitive sensing element 24″ is connected to a second article, so as to permit measurement of the relative angular displacement between the articles. The first article can be for example a rotating shaft. The second article can be for example a stationary base. However, the second article can also be nonstationary, such as another rotating shaft.

FIG. 5 shows the arrangement of magnetosensitive device 24″ within the working air gap 22″ when magnet assembly 200′ is at a selected zero position, or reference position, for a first article relative to a second article. At the selected zero position, nonuniform magnetic field B″ is oriented with respect to magnetosensitive device 24″ so as to produce a substantially zero output signal from device 24″. This is achieved by positioning the reference direction T′ of device 24″ perpendicular to direction D″ of magnetic field B″, as shown. The reference direction T′ could also be inverted from that of FIG. 5, which would correspondingly invert the output of the position sensor for the same range of rotary motion. Also, the magnetosensitive device could be located 180 degrees from the position shown in FIG. 5 at a first selected distance greater than zero mm of magnitude X, keeping the same reference direction T′ with respect to direction D″ as in FIG. 5, which would not change the output of the position sensor. These variations of location and orientation for the magnetosensitive device within the working air gap, and the resultant effects if any on the polarity of the output signal, are contemplated by the present invention.

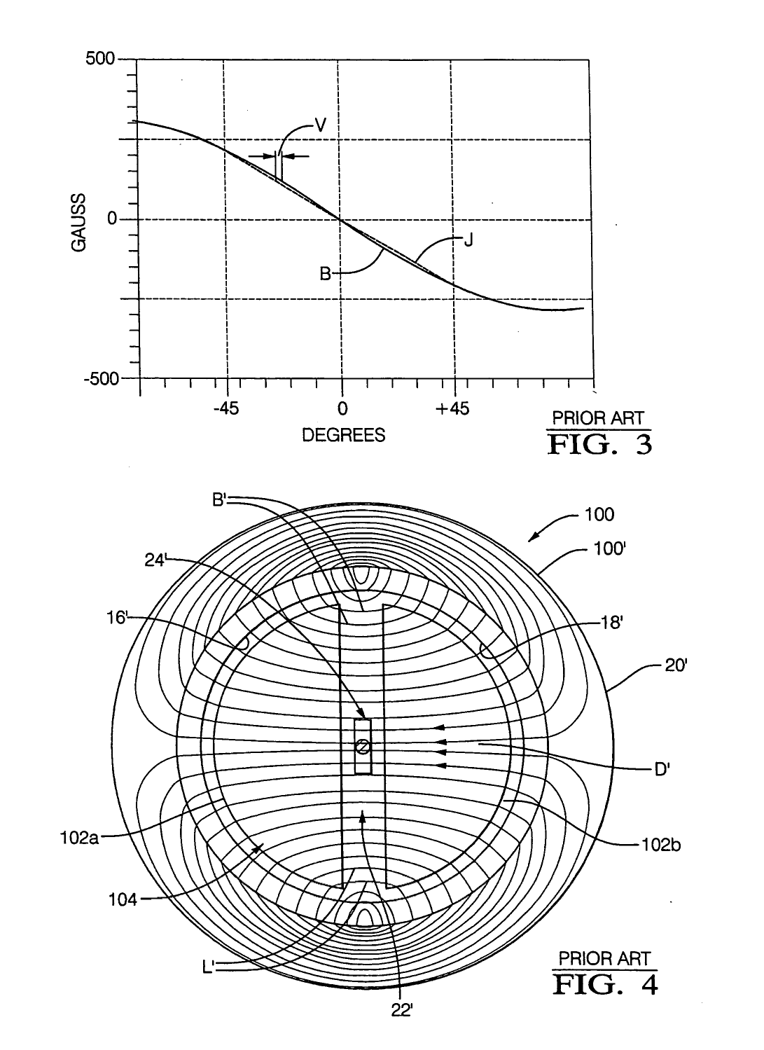

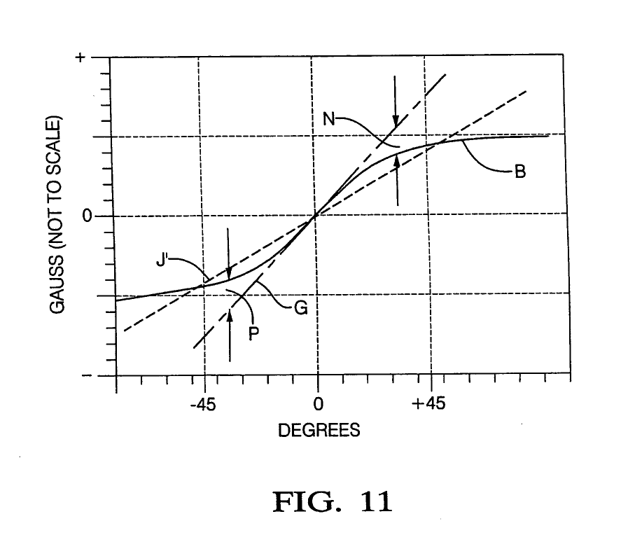

The operation of the invention of FIG. 5 is first described with reference to FIG. 11, which is another graph of magnetic field strength B versus angular position for the sensor of FIG. 2, wherein B is shown not to scale for the purpose of illustration. For FIGS. 2 and 11, positive rotation of magnet assembly 14 with respect to magnetosensitive device 24 is now defined as counterclockwise rotation, and produces a positive output signal. Because of its sinusoidal nature, the magnitude of the output signal B in FIG. 11 is attenuated from a desired linear response defined for example by line G tangent to the position sensor's response at 0 degrees. This signal attenuation is exemplified by negative excursion N. Note that line G has a greater slope than that of line J′ which passes through the position sensor's output at 0 degrees and ±45 degrees, similar to line J in FIG. 3. Methods for changing the calibration of a position sensor to accommodate a different slope in the response are known in the art. In order to operate near line G and thereby linearize the output as desired, it is necessary to add a component to the sensor response which is positive, in order to offset the negative excursion at N. This positive offset is supplied in the present invention by a contribution from the signal component due to the magnetosensitive device moving into a region of the magnetic field having a higher flux density. The effect of this can be illustrated for example by a magnetosensitive device centered within a nonuniform magnetic field like that of FIG. 2 and oriented at a selected angle with respect to the magnetic field so as to produce a positive output signal. As the magnetosensitive device is then translated in one direction or the other within the working air gap along an imaginary line perpendicular to the direction of the magnetic field, the output of the magnetosensitive device increases at an approximately exponential rate in the positive direction due to the progressively increasing flux density at the extremities of the nonuniform magnetic field. In other words, a first selected distance greater than zero mm X can be found for the sensor of FIG. 5 at which the increase in output signal due to the increasing flux density optimally offsets the sinusoidal nature of the component due to rotation of the magnetic field about the magnetosensitive device. The sum of these components, in terms of their respective magnitudes and directions, produces the desired substantially linear response of the present invention. Referring to FIG. 6 as an example of this, magnet assembly 200′ has rotated approximately 45 degrees in the positive, i.e. counterclockwise, direction from the zero position. The sensing element 24″ has now effectively been shifted into a region R of the nonuniform magnetic field B″ having a higher flux density than at the zero position. Nonuniform magnetic field B″ is oriented with respect to the sensing element so as to produce a component in the output signal due to the higher flux density which is positive. The component of the output signal due to rotation of magnetic field B″ about the sensing element is sinusoidal in nature, and for positive angular motion produces a negative excursion in the sensing element's output as compared to a desired linear response like G in FIG. 11. According to the present invention, the component of the magnetosensitive device's output signal due to the higher flux density is additive to the component of the output signal due to rotation of the magnetic field about the magnetosensitive device. Therefore the component of the signal due to the higher flux density tends to counteract the sinusoidal nature of the output signal due to rotation of the magnetic field, thereby effectively reducing the deviation from linearity for the response of the position sensor.

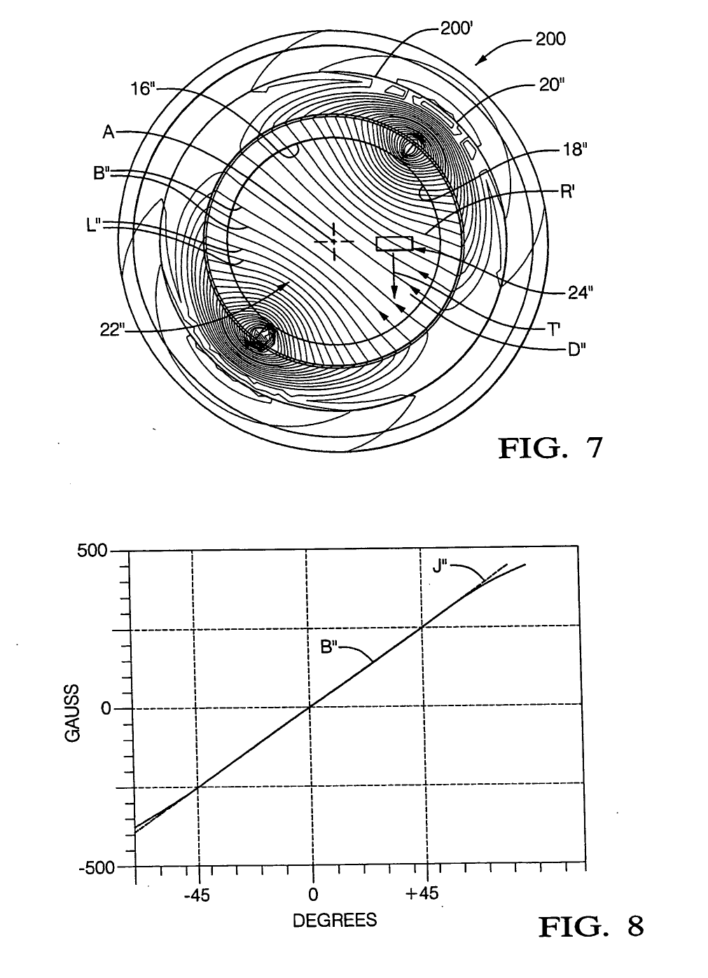

Referring to FIG. 7, the magnet assembly 200′ has rotated approximately 45 degrees clockwise, the negative direction, from the zero position. The sensing element 24″ has now effectively been shifted into a region R′ of the nonuniform magnetic field B″ having a higher flux density than at the zero position. For the position of FIG. 7, nonuniform magnetic field B″ is oriented with respect to the sensing element so as to produce a component in the output signal due to the higher flux density which is negative. The component of the output signal due to rotation of nonuniform magnetic field B″ about the sensing element is sinusoidal in nature, and for negative angular motion produces a positive excursion similar to the one at P in FIG. 11, compared to a desired linear response. As described above, the component of the sensing element's output signal due to the higher flux density is additive to the component of the output signal due to rotation of the magnetic field, thereby linearizing the total output signal.

FIG. 8 is a graph of magnetic field strength B″ versus angular position measured for the rotary position sensor of FIGS. 5 through 7. For FIG. 8 the first selected distance X was about 2 mm. The magnitude of the resulting maximum output signal error with respect to line J″, which passes through the sensor's output at 0 and ±45 degrees similar to line J in FIG. 3, was roughly about 0.5 degree of rotation or less based on visual interpretation of the measured data. FIG. 8 also suggests that substantially linear operation is possible with the present invention for a range of motion somewhat greater than ±45 degrees.

Referring to FIG. 5 again, in another embodiment the position sensor's axis of rotation A′ is located on imaginary line I between permanent magnet poles 26, 28, and furthermore is between the center C of magnetic field B″ and the magnetosensitive device 24″, the magnetosensitive device being offset a first selected distance greater than zero mm Y from axis A′. Axis of rotation A′ is not skewed with respect to magnet assembly 200′ but rather is substantially parallel to the longitudinal axis (not shown) of the rotary position sensor. For a given increase in angular position magnitude, the effect of this arrangement is to enhance the signal component due to rotation of the magnetic field about the sensing element, where this is desirable for producing a more linear output signal. Referring to FIG. 5 again, in yet another embodiment the position sensor's axis of rotation A″ is located on imaginary line I between permanent magnet poles 26, 28 in the quadrant opposite that of the magnetosensitive device, with the magnetosensitive device being offset a first selected distance greater than zero mm Z from axis A″. Axis of rotation A″ is, again, not skewed with respect to magnet assembly 200′. For a given increase in angular position magnitude, the effect of this arrangement is to enhance the signal component due to the progressively increasing magnetic flux density, where this desirable for producing a more linear output signal. For this embodiment the permissible range of angular motion may be affected, since for a sufficiently large increase in magnitude the sensing element may contact one of the permanent magnet arcs.

Referring to FIGS. 9 through 11, aspects of another rotary position sensor 300 utilizing a rectangular or bar magnetic circuit according to the present invention are shown. Rotary position sensor 300 includes a magnet assembly 300′ supported by a shaft (not shown) having a permanent magnet 316 formed from a magnetic material such as for example sintered Sm₂Co₁₇ or SmCo₅. Alternatively, the permanent magnet could be formed by plastic injection molding, i.e. “bonded.” Magnet assembly 300′ further includes a pair of pole pieces 310, 312 composed of ferromagnetic material such as low carbon steel. Each pole piece 310, 312 has a face 320f, 322f which is in good contact with a respective permanent magnet pole 320, 322 of permanent magnet 316, thereby providing minimal reluctance to the magnetic circuit at the interface therebetween. Alternatively, magnet assembly 300′ could be made from a single “U-shaped” magnet, with a nonuniform magnetic field provided between the two arms of the “U” such that the arms serve as a substitute for the pair of pole pieces 310, 312. A nonuniform magnetic field B′″ is provided within a working air gap 22′″ between the pole piece faces 310f, 312f, having a direction indicated by arrowheads D′″, and locally defined by lines of magnetic flux L′″ emanating from pole piece faces 310f, 312f, respectfully. The magnet assembly 300′ is connected to a first article. A magnetosensitive device 24′″ having a reference direction indicated by arrow T″ is located within the working air gap 22′″ for at least a portion of the sensor's angular range of motion. The magnetosensitive device is connected to a second article so as to permit measurement of the relative angular displacement between the articles. Furthermore, the reference point M′ of magnetosensitive device 24′″ is located at a first selected distance greater than zero mm X′ from the axis of rotation A′″. In an exemplary embodiment the first selected distance X′ is about one mm to about two mm. The position sensor's axis of rotation A′″ is located between magnetosensitive device 24′″ and permanent magnet 316 along an imaginary line I′, wherein I′ is a centerline of permanent magnet 316 that passes through working air gap 22′″. Axis of rotation A′″ is not skewed with respect to magnet assembly 300′ but rather is substantially parallel to the longitudinal axis (not shown) of the rotary position sensor. For purposes of describing this invention, “parallel” to a given axis or line includes “coincident” with the given axis or line. The reference direction is oriented substantially parallel to an imaginary line passing through the reference point perpendicular to the axis of rotation. The pair of pole pieces 310, 312 are of a geometry such that the magnetosensitive device 24′″ can be located between the pole piece faces 310f, 312f. In an exemplary embodiment the distance between the pole piece faces is a second selected distance of about six mm, and the distance between permanent magnet 316 and axis of rotation A′″ is a third selected distance of about two mm.

Referring to FIG. 9 again, magnet assembly 300′ is shown at a selected zero position for a first article relative to a second article. The zero position can be defined as shown where sensing element 24′″ is further located along imaginary line I′. In the zero position, the nonuniform magnetic field B′″ is oriented with respect to magnetosensitive device 24′″ so as to produce a substantially zero output signal from the magnetosensitive device. This is achieved by positioning the reference direction T″ of device 24′″ perpendicular to direction D′″ of magnetic field B′″, as shown.

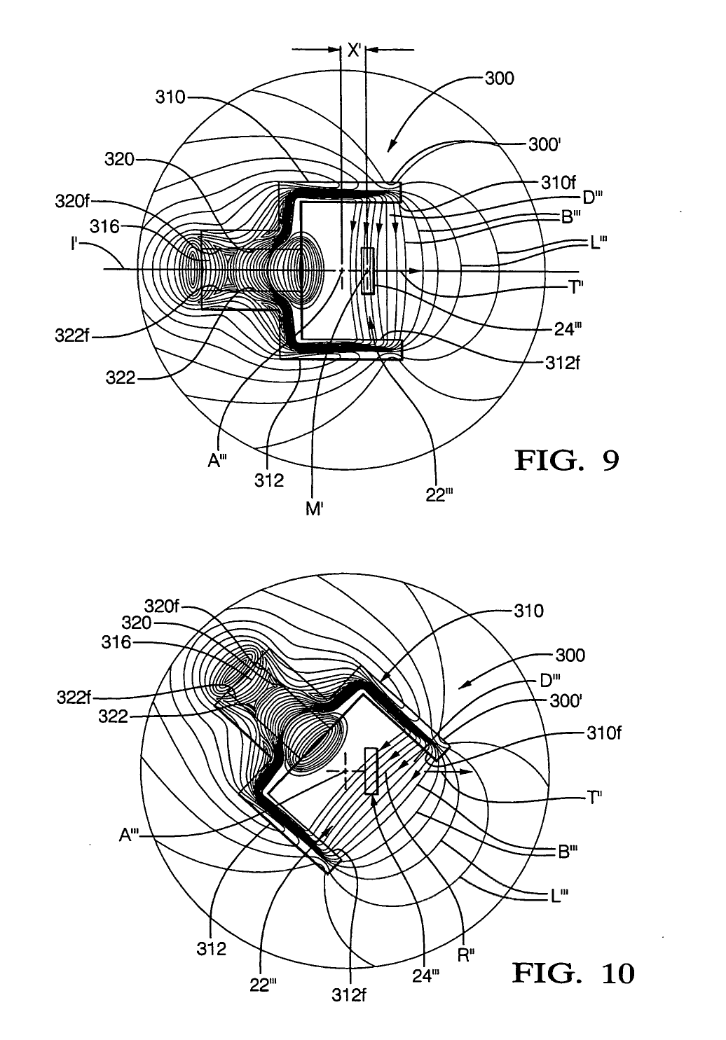

As the magnet assembly moves from the zero position about the position sensor's axis of rotation, the magnetosensitive device is subjected to a magnetic field of progressively increasing flux density, consistent with the description for the embodiment of FIGS. 5 through 7 above. In FIG. 10, magnet assembly 300′ has moved approximately 45 degrees in the clockwise, herein defined as negative, direction from the zero position. Similar to the condition described above for FIG. 7, nonuniform magnetic field B′″ is now oriented with respect to the sensing element so as to produce a component in the output signal due to the progressively increasing flux density at R″ which is negative. The component of the output signal due to rotation of nonuniform magnetic field B′″ about the sensing element is sinusoidal in nature, and for negative angular motion produces a positive excursion similar to the one at P in FIG. 11, compared to a desired linear response. As described above, the component of the sensing element's output signal due to the progressively increasing flux density at region R″ is additive to the component of the output signal due to the rotation of magnetic field B″. The sum of these components, in terms of their respective magnitudes and directions, produces the desired substantially linear response of the present invention without using other elements such as ferromagnetic flux shapers. Magnetic field strength B′″ versus angular position for the rotary position sensor of FIGS. 9 and 10 was measured in a fashion similar to that described for FIG. 8. The magnitude of the resulting maximum output signal error for a first selected distance X′ of about one mm was believed to be about the same as for the sensor of FIGS. 5 through 7.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A rotary position sensor 200, 300 having an axis of rotation A, A′, A″, A′″, comprising:
a magnet assembly 200′, 300′ having first and second poles 26, 28, 320, 322 wherein a working air gap 22″, 22′″ is provided between the first and second poles 26, 28, 320, 322;
a magnetosensitive device 24″, 24′″ having a reference point M, M′, wherein the reference point M, M′ is located within the working air gap 22″, 22′″;
wherein the axis of rotation A, A′, A″, A′″ to the reference point M, M′ is a first selected distance X, Y, Z, X greater than zero; and
wherein the working air gap 22″, 22′″ is a second selected distance.

2. The sensor 200 of claim 1, the magnetosensitive device 24″ further having a reference direction T′, the reference direction T′ being oriented substantially perpendicular to an imaginary plane passing through the reference point M and the axis of rotation A, A′, A″.

3. The sensor 200 of claim 2, further wherein the axis of rotation A, A′, A″ is located along an imaginary line I between the first and second poles 26, 28.

4. The sensor 200 of claim 3, further wherein the axis of rotation A is located substantially midway C between the first and second poles 26, 28.

5. The sensor 200 of claim 3, wherein the magnet assembly 200′ further comprises a magnetic element 16″, 18″ selected from the group consisting of a permanent magnet arc and a ring magnet.

6. The sensor 200 of claim 5, wherein the magnet assembly further comprises a flux carrying ring 20″; and
means for affixing the magnetic element 16″, 18″ to the flux carrying ring 20″.

7. The sensor 200 of claim 6, wherein the magnetic element 16″, 18″ is composed of Sm₂Co₁₇.

8. The sensor 200 of claim 3, wherein the magnet assembly 200′ further comprises a magnetic element 16″, 18″ selected from the group consisting of a rectangular magnet and a bar magnet.

9. The sensor 200 of claim 3, wherein the first selected distance X is greater than about 0.4 mm.

10. The sensor 200 of claim 3, wherein the first selected distance X is greater than about 0.8 mm

11. The sensor 200 of claim 3, wherein the first selected distance X is about 2% to about 40% of the second selected distance.

12. The sensor 200 of claim 3, wherein the first selected distance X is about 8% to about 30% of the second selected distance.

13. The sensor 200 of claim 3, wherein the first selected distance X is about 15% to about 25% of the second selected distance.

14. The sensor 300 of claim 1, further wherein the axis of rotation A′″ is located between the magnet assembly 300′ and the magnetosensitive device 24′″ along a centerline I′ of the magnet assembly 300′ passing through the working air gap 22′″.

15. The sensor 300 of claim 14, the magnetosensitive device 24′″ further having a reference direction T″, the reference direction T″ being oriented substantially parallel to an imaginary line passing through the reference point M′ perpendicular to the axis of rotation A′″.

16. A rotary position sensor 300 having an axis of rotation A′″, comprising:
a permanent magnet 316 having first and second poles 320, 322;
a first pole piece 310 wherein a portion thereof abuts the first pole 320, the first pole piece 310 having a first pole piece face 310f;
a second pole piece 312 wherein a portion thereof abuts the second pole 322, the second pole piece 312 having a second pole piece face 312f;
wherein a working air gap 22′″ is provided between the first and second pole piece faces 320f, 322f;
a magnetosensitive device 24′″ having a reference point M′ wherein the reference point M′ is located within the working air gap 22′″;
wherein the axis of rotation A′″ is substantially located between the permanent magnet 316 and the magnetosensitive device 24′″ along a centerline I′ of the permanent magnet 316 passing through the working air gap 22′″;
further wherein the axis of rotation A′″ to the reference point M′ is a first selected distance X′ greater than zero;
further wherein the working air gap 22′″ is a second selected distance;
further wherein the permanent magnet 316 has a side facing the working air gap;
further wherein the side to the axis of rotation A′″ is a third selected distance.

17. The sensor 300 of claim 16, the magnetosensitive device 24′″ further having a reference direction T″, the reference direction T″ being oriented substantially parallel to an imaginary line passing through the reference point M′ perpendicular to the axis of rotation A′″.

18. The sensor 300 of claim 17, wherein the first selected distance X′ is greater than about 0.4 mm.

19. The sensor 300 of claim 17, wherein the first selected distance X′ is greater than about 0.8 mm.

20. The sensor 300 of claim 17, wherein the first selected distance X′ is about 4% to about 70% of the second selected distance.

21. The sensor 300 of claim 17, wherein the first selected distance X′ is about 10% to about 50% of the second selected distance.

22. The sensor 300 of claim 17, wherein the first selected distance X′ is about 13% to about 37% of the second selected distance.

23. The sensor 300 of claim 20, wherein the third selected distance is from about 15% to about 70% of the second selected distance.

24. The sensor 300 of claim 20, wherein the third selected distance is from about 25% to about 50% of the second selected distance.

25. The sensor 300 of claim 20, wherein the third selected distance is from about 30% to about 35% of the second selected distance.

26. The sensor 300 of claim 20, wherein the permanent magnet 316 is composed of Sm₂Co_{17.}

27. The sensor 300 of claim 20, wherein the first and second pole pieces 310, 312 are composed of ferromagnetic material.
